(19) United States
(12) Patent Application Publication
(10) Pub. No.: US 2026/0327394 A1
(43) Pub. Date: Oct. 22, 2026

(54) RECYCLING WASTE MEMBRANE COMPRISING FLUORINATED IONOMER

(71) Applicant: JOHNSON MATTHEY PUBLIC LIMITED COMPANY, London (GB)

(72) Inventors: Bethan Haf COULSON, Sonning Common (GB); Denis DUCHESNE, Wayne, PA (US); Ross GORDON, Sonning Common (GB); Gareth HART, Sonning Common (GB); Krishna MISTRY, Sonning Common (GB)

(21) Appl. No.: 19/115,101

(22) PCT Filed: Nov. 16, 2023
(86) PCT No.: PCT/GB2023/053009

§ 371 Date: Mar. 25, 2025

Related U.S. Application Data
(60) Provisional application No. 63/385,814, filed on Dec. 2, 2022.

(30) Foreign Application Priority Data
Jan. 11, 2023 (GB) 2300414.6

(51) Int. Cl. C08J 11/08; B01D 15/08; B01D 15/36; B09B 3/80; B09B 101/15; H01M 8/008

(52) U.S. Cl. CPC C08J 11/08; B01D 15/08; B01D 15/362; B01D 15/363; B09B 3/80; H01M 8/008; B09B 2101/15

(57) ABSTRACT

A method of recycling waste membrane comprising fluorinated ionomer, the method comprising: dispersing the fluorinated ionomer from the waste membrane in a solvent; components separating the fluorinated ionomer from the solvent, wherein after separating the fluorinated recycling ionomer, the solvent is in the form of a waste dispersion media comprising the solvent and fluorine containing species in the solvent; and treating the waste dispersion media to reduce the concentration of the fluorine containing species in the solvent.

### FIELD

This specification relates to recycling methods for components of catalyst coated membranes such as those used in fuel cells and hydrogen producing water electrolysers.

### BACKGROUND

Fuel cell and hydrogen producing water electrolyser production is set for rapid growth as investment is placed into the global hydrogen economy. Catalyst coated membranes (CCMs) are a major functional component of both fuel cells and electrolysers. Such CCMs generally comprise a conductive polymer membrane coated on either side by a catalyst containing layer. The CCMs are configured to drive oxidation and reduction reactions and support proton and electron transport, these processes been required for the fuel cell and electrolyser technologies to function.

While variations in CCM component materials and configurations exist according to functional performance requirements in end use applications, they generally contain several components of value including one or more platinum group metal (PGM) catalysts and one or more proton conducting polymers.

Typically, the membrane is formed of one or more ionomers such as perfluorosulfonic-acid (PFSA) ionomers. Ionomer may also be provided in one or both of the catalyst layers. The ionomer in the catalyst layers may be the same or different to the ionomer in the main membrane component and/or in other catalyst layer(s).

A CCM may comprise two different catalysts, one for driving an oxidation reaction on one side of the CCM and one for driving a reduction reaction on the other side of the CCM. A CCM may also comprise a recombination catalyst which is provided to catalyse the recombination of hydrogen and oxygen to form water, reducing the quantity of hydrogen crossing the membrane and mixing with oxygen to form a potentially explosive mixture. A CCM may also include a multivalent cation delivered as a salt or oxide (supported or unsupported) as a peroxide scavenger, e.g., a metal oxide such as CeO₂.

CCM catalysts can be based on platinum group metals such as platinum, ruthenium, iridium, palladium, or mixtures thereof. The platinum group metals may be provided in elemental (metallic) form, in compound form (e.g., an oxide, such as an iridium oxide catalyst), or as a PGM-base metal alloy (e.g., PtCo). Furthermore, the PGM catalyst materials may be supported on a substrate material, such as a carbonaceous substrate material (e.g., carbon, such as a platinum-on-carbon catalyst comprising particles of carbon on which platinum is disposed or PtCo-on-carbon, or an organic material, e.g., nanostructured thin film catalyst (NTFC) technology as described in US2020102659 and WO2006089180).

Catalyst coated membranes (CCMs) can also be provided in combination with additional functional layers to form multi-layer membrane electrode assemblies (MEAs). Such MEAs may have 3, 5, or 7 layers for example.

With the increase in CCM manufacture for fuel cells and electrolysers, there is an associated increase in CCM waste materials, including a significant volume of scrap material created during CCM manufacture (e.g., due to failure at quality control) and also an increase in end-of-life (EoL) CCMs.

Since CCMs contain several components which are rare and/or valuable, including platinum group metals (notably Pt, Pd, Ir and Ru) and ionomer (both in the membrane and catalyst layers), there is a growing demand for methods of recycling such components from waste CCM materials.

One current method to recover PGMs from production scrap and end-of-life CCM material involves incineration. The incineration process yields a PGM rich (typically Pt and Ir) ash which is processed via conventional PGM refining routes. However, the incineration process releases harmful and toxic gases such as CO₂ and HF from the polymers that are part of the membrane. Both these gases have negative impacts as they pollute the atmosphere, increase the greenhouse effect, and/or have harmful effects in the human body. As such, there is a need for a cleaner process which reduces or eliminates the emission of these gases.

In addition to the above, the incineration method destroys the ionomer component which also has significant value. As such, it would also be desirable to provide a process which is capable of recovering both PGM and ionomer components as well as providing a process which is cleaner, safer, and more environmentally friendly. Processes for recovering perfluorosulphonic acid ionomer are known. See, for example, WO2016/156815 and U.S. Pat. No. 7,255,798. Furthermore, processes for recovering individual PGM catalyst components are known. See, for example, U.S. Pat. No. 7,709,135. Several other prior art documents which disclose methods of recycling components of CCMs are discussed below.

EP3275036 discloses a method comprising: immersing a CCM in a diol solvent; heating to obtain a dispersion comprising solvent, one or more ionomers, and one or more catalyst components; and filtering the dispersion to separate the solvent and the one or more ionomers from the one of more catalyst components.

A paper entitled “PEM water electrolysis: Innovative approaches towards catalyst separation, recovery and recycling” (International Journal of Hydrogen Energy 44 (2019) 3450-3455) discloses a method of recycling a CCM to recover membrane ionomer, iridium oxide catalyst and Pt/C catalyst. This is achieved by mounting the CCM across a reactor so as to define two separate chambers, one on the iridium oxide side of the CCM and one on the Pt/C side of the CCM. Both sides of the CCM are then separately subjected to a circulation of a solution consisting of deionized water and alcohol. It is described that complete delamination of the catalyst layers from the membrane occurs after 10-30 minutes. After delamination the membrane is dried, re-used or reprocessed. The two separate dispersions comprising the catalyst residues are centrifuged and the solids collected and dried in an oven to yield recycled iridium oxide catalyst powder and recycled Pt/C catalyst powder. The recycled catalyst powders are used to fabricate new CCMs. It is disclosed that the temperature used when drying the recycled catalysts was not high enough to burn off ionomer in the catalyst powders and it is indicated that the ionomer present when re-using the catalyst powders in new ink formulations may be responsible for increased cell voltages (reduced performance) in CCMs manufactured using the recycled catalyst materials.

CN106898790 also discloses a method in which the catalyst layers are delaminated from the membrane using an alcohol-water mixture and then the solid membrane is separated from the catalyst layer dispersion. The catalyst layer dispersion and the solid membrane are then processed and recycled separately. In contrast to the previously discussed paper, it is described that the catalyst layer dispersion is processed by heating to a sufficient temperature to burn off the catalyst layer ionomer and then heated further under higher temperatures to remove carbon and retrieve precious metal catalyst.

To enable fuel cells and electrolysers to become more sustainable technologies, there remains a need for commercially viable and environmentally friendly routes to recover, separate, and recycle both the PGMs and the ionomer components from waste CCM materials including production scrap and end-of-life material. It is an aim of the present specification to address this problem.

### SUMMARY OF INVENTION

According to the present specification there is provided a method of recycling waste membrane comprising fluorinated ionomer, the method comprising:
dispersing the fluorinated ionomer from the waste membrane in a solvent (which bay be selected from water, an alkaline aqueous solution, or a water/alcohol mixture);
separating the fluorinated ionomer from the solvent, wherein after separating the fluorinated ionomer, the solvent is in the form of a waste dispersion media comprising the solvent and fluorine containing species in the solvent (e.g., soluble fluorine containing organic compounds dissolved in the solvent, soluble ionic fluoride species dissolved in the solvent, and/or insoluble fluorine containing compounds dispersed in the solvent such as insoluble metal fluoride salts); and
treating the waste dispersion media to reduce the concentration of fluorine containing species in the solvent.

After treatment of the waste dispersion media to reduce the concentration of fluorine containing species in the solvent, the solvent can be safely discarded or recycled for re-use in processing further waste membrane material. The advantages of this waste dispersion media processing method include a reduction of emissions resulting from the recycling of ionomers from production scrap and/or end-of-life fuel cell and/or water electrolyser CCM components. Reduction in water consumption is also advantageous.

The treatment of the waste dispersion media may comprise one or more of the following steps to reduce the concentration of fluorine containing species in the solvent: contacting the waste dispersion media with a solid adsorbent; contacting the waste dispersion media with one or more ion exchange media; filtering the waste dispersion media. For example, the waste dispersion media may be contacted with an adsorbent such as activated charcoal, a cationic ion exchange resin, an anionic ion exchange resin, or a combination of said media. The treatment of the waste dispersion media may also reduce the concentration of residual metal cations in the solvent such as one or more of iron, nickel, copper, and chrome.

Advantageously, the waste dispersion media can be subjected to crossflow filtration or ultrafiltration, e.g., prior to contacting the waste dispersion media with an adsorbent and/or ion exchange media. This can aid to concentrate the fluorine containing impurities prior to the capture and disposal of these impurities.

The waste membrane may be from a fuel cell or water electrolyser component (either manufacturing scrap or end-of-life material). For example, the waste membrane can be a waste catalyst coated membrane comprising a membrane including a membrane ionomer, a first catalyst layer disposed on one side of the membrane, the first catalyst layer comprising a first catalyst and a first catalyst layer ionomer, and a second catalyst layer disposed on an opposite side of the membrane, the second catalyst layer comprising a second catalyst and a second catalyst layer ionomer. In this case, the waste dispersion media is generated from a dispersion of at least one of the membrane ionomer, the first catalyst layer ionomer, and the second catalyst layer ionomer.

According to certain examples, the method comprises contacting the waste catalyst coated membrane with a solvent to delaminate both of the first and second catalyst layers from the membrane without dispersing the membrane, wherein the first and second catalyst layers form a catalyst layer slurry comprising the first catalyst, the first catalyst layer ionomer, the second catalyst, and the second catalyst layer ionomer. The membrane can be separated from the catalyst layer slurry and processed to disperse and recover the membrane ionomer. The catalyst layer slurry can be processed to disperse and recover the first and second catalyst layer ionomers, and separate and recover the first and second catalysts or components thereof. In this methodology, processing of the membrane generates a first waste dispersion media comprising a first solvent and fluorine containing species in the first solvent, and the first waste dispersion media is treated to reduce the concentration of fluorine containing species in the first solvent. Furthermore, processing of the catalyst layer slurry generates a second waste dispersion media comprising a second solvent and fluorine containing species in the second solvent, and the second waste dispersion media is also treated to reduce the concentration of fluorine containing species in the second solvent. The first and second waste dispersion media can be combined prior to treatment in order to reduce the concentration of fluorine containing species (e.g., if the first and second solvents are the same). Alternatively, the first and second waste dispersion media can be treated separately in order to reduce the concentration of fluorine containing species (e.g., if the first and second solvents are different). In the latter case, the two different solvents can be separately recycled and re-used in the process.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a waste CCM recycling process wherein the catalyst layers are first separated from the bulk polymer membrane (noting that gas diffusion layer(s) and seal(s) can be removed prior to treatment of the waste CCM);

FIG. 2 shows a method of further processing the catalyst layer material;

FIG. 3 shows an alternative method of further processing the catalyst layer material;

FIG. 4 shows: (a) a catalyst coated membrane subjected to size reduction (cutting) and immersion in an alcohol: water mixture (left hand image); (b) after ultra-sonication wherein the catalyst layer is dispersed in the alcohol: water mixture (middle image); and (c) the delaminated, clean and clear membrane recovered from the alcohol: water mixture (right hand image);

FIG. 5 shows images of dispersions and recovered membranes after treatment of catalyst coated membranes in a range of different alcohol: water mixtures indicating that methanol is not effective at delaminating catalyst layers from membrane (image a) whereas the order of effectiveness of other alcohols at achieving delamination of catalyst layers and recovery of clean and clear membrane is as follows: n-butanol>n-propanol>i-propanol>ethanol (image b); and

FIG. 6 shows an example of a process flow for treatment of waste dispersion media in a CCM recycling process.

### DETAILED DESCRIPTION

As described in the summary section, the present specification is concerned with providing a method of recycling fluorine containing ionomer from fuel cell or water electrolyser waste membrane material (e.g., catalyst coated membranes—CCMs). The method is advantageous in that it enables waste dispersion media generated during the recycling process to be treated to remove harmful fluorine containing species so that they are safe to dispose of or, advantageously, so that the solvents used in the process can be recycled and re-used in the process.

CCMs may contain ionomer in one or both of the catalyst layers as well as in the bulk ionomer membrane on which the catalyst layers are disposed. To optimize performance parameters for the CCMs, different ionomers can be used in the catalyst layers and bulk ionomer membrane. The present specification includes a method in which the catalyst layer ionomers can be separated from the membrane ionomers and wherein the catalyst layer ionomers are processed separated from the membrane ionomer such that both membrane and catalyst layer ionomers are recovered in addition to PGM containing catalyst materials. This method can generate waste dispersion media from both the processing of the membrane ionomer and the catalyst layer ionomer. Advantageous, both these sources of waste dispersion media are treated to remove harmful fluorine containing species so that the solvents used in the process can be recycled and re-used in the process.

According to one approach, a method of recycling a waste catalyst coated membrane is provided, wherein the waste catalyst coated membrane comprises a membrane including a membrane ionomer, a first catalyst layer disposed on one side of the membrane, the first catalyst layer comprising a first catalyst and a first catalyst layer ionomer, and a second catalyst layer disposed on an opposite side of the membrane, the second catalyst layer comprising a second catalyst and a second catalyst layer ionomer, the method comprising:
contacting the waste catalyst coated membrane with a solvent to delaminate both of the first and second catalyst layers from the membrane without dispersing the membrane, wherein the first and second catalyst layers form a catalyst layer slurry comprising the first catalyst, the first catalyst layer ionomer, the second catalyst, and the second catalyst layer ionomer;
separating the membrane from the catalyst layer slurry;
processing the membrane to recover the membrane ionomer; and
processing the catalyst layer slurry to disperse and recover the first and second catalyst layer ionomers in a solvent, and separate and recover the first and second catalysts or components thereof.

The processing of the catalyst layer slurry may comprise:
heating the catalyst layer slurry to disperse the first and second catalyst layer ionomers forming an ionomer dispersion in which solid first and second catalyst materials are disposed;
separating the solid first and second catalyst materials from the ionomer dispersion (e.g., using a solid-liquid separation technique such as filtration);
processing the ionomer dispersion to recover the first and second catalyst layer ionomers; and
processing the solid first and second catalyst materials to separate and recover the first and second catalyst materials or components thereof.

The step of heating the catalyst layer slurry to disperse the first and second catalyst layer ionomers can be performed in the same solvent used to delaminate the first and second catalyst layers from the membrane. Alternatively, the catalyst slurry can be processed to adjust the solvent composition or remove the solvent used in the delamination process, and then the material can thus be re-slurried in a different solvent to disperse and separate the catalyst layer ionomer. One or more of the catalyst layer components can be leached either before and/or after the material is re-slurried to disperse the catalyst layer ionomer material.

Typically, the step of heating the catalyst layer slurry to disperse the first and second catalyst layer ionomers is performed at a higher temperature than the step of contacting the waste catalyst coated membrane with the solvent to delaminate both of the first and second catalyst layers from the membrane without dispersing the membrane. This is especially the case if the solvent in which the dispersion is performed is the same solvent used to delaminate the catalyst layers from the membrane. In the delamination process the temperature is kept sufficiently low that the membrane ionomer does not disperse but the catalyst layers delaminate and form a slurry. Then after separating the membrane from the slurry, the slurry can be increased in temperature to disperse the catalyst layer ionomer and separate from the solid catalyst materials. The step of heating the catalyst layer slurry to disperse the first and second catalyst layer ionomers in the solvent can also be performed at elevated pressure in an autoclave.

Processing of the catalyst layer slurry may further comprise converting the first and second catalyst layer ionomers to salt form. Salt formation (e.g., by treatment with a base) protects the sulfonic acid groups of the ionomer during the recovery process, after which the salt form of the first and second catalyst layer ionomers can be converted back to acid form by proton exchange. The catalyst layer ionomer dispersion is also advantageous subjected to ion-exchange to remove metal contaminants.

The first and second catalyst layer ionomers can be recovered from the ionomer dispersion as a blend of the first and second catalyst layer ionomers or alternatively the ionomer dispersion can be processed to separate the first and second catalyst layer ionomers.

In catalyst coated membranes which have different ionomer in the catalyst layers compared to the bulk ionomer membrane, a process to delaminate the catalyst layers can be used to separate the different types of ionomers in the membrane and catalyst layers so that the different types of ionomers can be processed separately. In this regard, it is noted that in prior art methods which involve dispersing both the catalyst layer ionomer and bulk membrane ionomer, where the ionomer in the catalyst layers is different to that in the bulk membrane it can then be difficult to separate the mixed ionomer dispersion, especially since there is a large amount of ionomer from the membrane. In the present methodology in which the catalyst layers are first delaminated and separated from the bulk membrane, the catalyst layer ionomer dispersion is processed separately from the majority of the CCM ionomer which remains in the membrane. The different types of ionomers can be more easily separated and the smaller volume of ionomer from just the catalyst layers is easier to process, e.g., to remove metal contamination and/or separate ionomer of different types.

The solvent used to delaminate both of the first and second catalyst layers from the membrane can be a mixture of an alcohol and water, wherein the alcohol in the mixture of the alcohol and water is selected from n-butanol, n-propanol, i-propanol, or ethanol. It has been found that while methanol and water is ineffective at delaminating catalyst layers from an ionomer membrane, a mixture of n-butanol, n-propanol, i-propanol, or ethanol with water can effectively delaminate the catalyst layers and disperse the catalyst layer ionomer without dispersing the bulk ionomer membrane. The order of effectiveness of these alcohols at achieving delamination of catalyst layers and recovery of clean and clear membrane is as follows: n-butanol>n-propanol>i-propanol>ethanol. Hence, the alcohol is preferably selected from n-butanol, n-propanol, or i-propanol, more preferably n-butanol or n-propanol, and most preferably n-butanol. Selection can be based on a suitable Hansen solubility parameter range.

The mixture of alcohol and water may have a volume ratio of alcohol: water between 0 and 1 and which is advantageously: at least 50:50, 60:40, or 70:30; no more than 95:5, 90:10, or 85:15; or within a range defined by any combination of the aforementioned lower and upper limits. The ratio can be optimized to enable effective delamination of the catalyst layers to form a catalyst layer slurry without dispersing the bulk ionomer membrane for a given set of process conditions and CCM feed materials for recycling.

The solvent (e.g., the mixture of alcohol and water) can be agitated to aid delamination of the catalyst layers, e.g., by sonification. Ultra-sonification has been found to be effective for use in the present method. Furthermore, during the step of contacting the membrane with the solvent to delaminate the catalyst layers, the solvent can be maintained at a temperature below 150 °C, 100 °C, 80 °C, 60 °C, or 40 °C, optionally greater than 5 °C, 10 °C or 15 °C, optionally within a range defined by any of the preceding upper and lower values. The temperature can be sufficiently low such that the catalyst layers delaminate without dispersing the fluorinated polymer membrane which remains in solid, undispersed form.

Contacting of the waste catalyst coated membrane with the solvent to delaminate the catalyst layers can be performed for a time period of: at least 10 minutes, 20 minutes, 30 minutes or 1 hour; no more than 5 hours, 3 hours, or 2 hours; or within a range defined by any combination of the aforementioned lower and upper limits. The specific time period for the deamination step with depend on a given set of process conditions (e.g., type/concentration of alcohol, temperature, pressure, agitation, etc.) and type of CCM feed material for recycling.

Advantageously, the waste catalyst coated membrane is processed into a plurality of pieces (e.g., by cutting) prior to contacting with the solvent to delaminate the catalyst layers. This can aid clean delamination of the catalyst layers from the bulk ionomer membrane as well as making it easier to handle and process large areas of waste catalyst coated membrane material (e.g., in amounts ranging from 5% to 100% of the original membrane).

Typically, the first catalyst may comprise platinum, palladium and/or ruthenium (optionally on a support material such as a carbon support material) and the second catalyst may comprise iridium (e.g., an iridium oxide material). The methodology is particularly suited to recycling catalyst coated membranes in which the membrane ionomer is different to one or both of the first and second catalyst layer ionomers. The catalyst layer ionomers may be the same or different from each other.

After delaminating the catalyst layers to yield a solid bulk ionomer membrane in a catalyst layer slurry, the solid bulk ionomer membrane can be separated from the slurry using a solid-liquid separation technique such as decanting and/or filtering. The solid bulk ionomer membrane can then be further processed to recover the membrane ionomer without interference from the catalyst layer ionomer. Further processing of the bulk ionomer membrane may include dispersing the membrane ionomer in a solvent and separating the dispersed membrane ionomer from other components of the bulk ionomer membrane such as reinforcement polymer. The recovered membrane ionomer can then be re-used to manufacture new membrane material.

The catalyst layer slurry is separately processed to recover the first and second catalyst layer ionomers and the first and second catalyst materials. For example, the first and second catalysts can be filtered from a dispersion of catalyst layer ionomer and then subjected to selective dissolve and refining steps to recover individual platinum group metals. Processing of the catalyst layer slurry may also comprise communition of catalyst layer material prior to selective dissolve and refining steps to recover individual platinum group metals. The remaining catalyst layer ionomer dispersion can be recycled for manufacturing new catalyst layer inks.

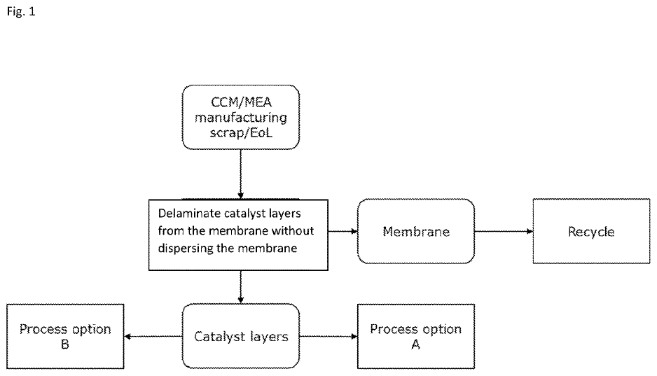

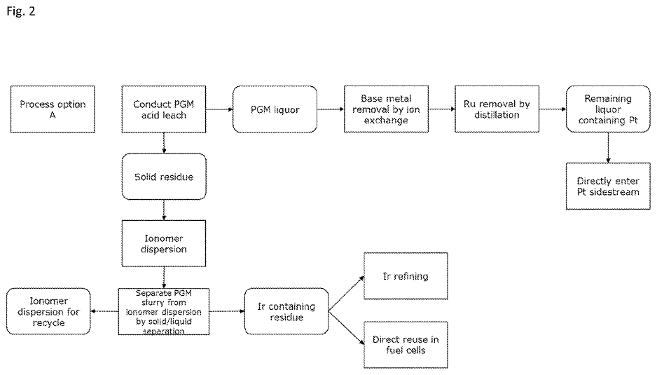

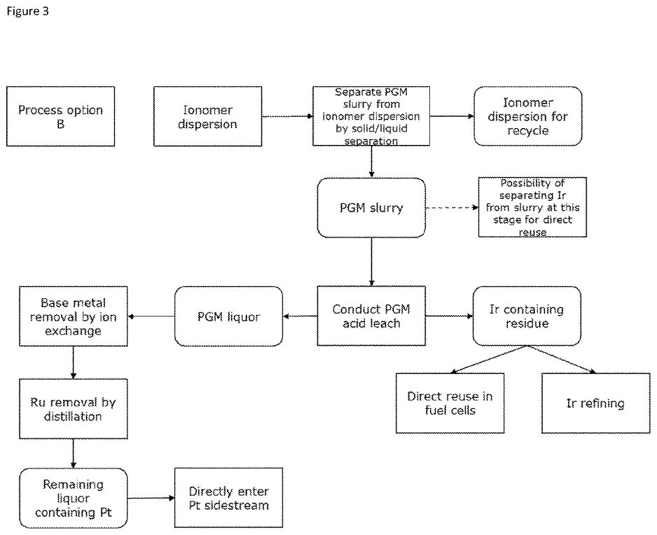

An example of a process flow is illustrated in FIG. 1. The first stage of this process involves separating the catalyst layers from the membrane. The CCM material can be immersed in an alcohol-water mixture and sonicated or otherwise agitated for a period of time where the catalyst layers separate and disperse into the solvent. Once the membrane and catalyst layers are separated cleanly, the membrane can be further processed to recover the membrane ionomer component. To recover the PGMs and ionomer in the catalysts layers there are two options A and B as illustrated in FIGS. 2 and 3.

Process Option A: The catalyst layer material can be subjected to HCl/oxidant (e.g. chlorine) treatment to leach the platinum. The liquor from this treatment can then be purified from base metals (using, for example, a cationic exchange resin), undergo Ru removal via a distillation or other process, and then enter directly into a Pt refining stream. The remaining Ir containing residue from the leach can undergo a process which involves heating/autoclaving the material in an alcoholic solvent to dissolve/disperse the ionomer. The ionomer dispersion is separated from the Ir containing solution via filtration or centrifugation (as an alternative, the Ir can be leached prior to or after ionomer dispersion). The ionomer dispersion then goes on for further processing to be recycled back to manufacture new CCMs. The Ir containing residue can either be processed in order to directly reuse the Ir catalyst or the residue can be refined to recover the Ir metal.

Process Option B: Alternatively, the catalyst layer material can be heated in alcoholic solvent to elevated temperature and optionally autoclaved to disperse the catalyst layer components. This resultant slurry then undergoes a solid/liquid separation by either filtration or centrifugation. The supernatant/filtrate contains dispersed ionomer which can then be further processed to be recycled back to manufacture new CCMs. The PGM residue is dried to ensure complete removal of organic solvent before being subject to a HCl/chlorine leach treatment. The liquor from this leach treatment can then be purified from base metals (using, for example, a cationic exchange resin), undergo Ru removal via a distillation process, and then enter directly into a Pt refining stream. The residue from the leach process still contains the Ir catalyst which will have been largely unchanged due to its stability. This can either be processed in order to directly reuse the Ir catalyst or the residue can be refined to recover the Ir metal.

Common features of the above-described catalyst layer recycling processes are the use of an oxidative acid leach to extract platinum (and/or palladium and/or ruthenium) material and an extraction of iridium either via a reductive leach or solid-liquid separation after extraction of the platinum and ionomer dispersion. The Pt leach can be applied before or after dispersing ionomer and before or after leaching of iridium. The process order can be: (i) iridium leach; (ii) platinum leach; (iii) processing of remaining catalyst layer ionomer. Alternatively, the process order can be: (i) platinum leach; (ii) iridium leach; (iii) processing of remaining catalyst layer ionomer. Alternatively still, an iridium leach is not required to separate the iridium from the ionomer. Rather, the iridium containing material is separated from the catalyst layer ionomer material by dispersing the ionomer material and using a solid/solution separation to remove the ionomer. In this case, the solid/liquid separation may be used for separation of insoluble Ir, Pt, Ru and/or Rh containing species/alloys. The platinum leaching step can be performed prior to the step of dispersing the ionomer as in FIG. 2. Alternatively, the ionomer dispersion step can be performed prior to the platinum leaching step as in FIG. 3. In either case, the process first separates the catalyst layers from the bulk polymer membrane and then applies the processing steps to the catalyst layer materials with the bulk ionomer membrane being processed separately.

The specific method to be utilized will depend on operator requirements, demand for components, and desired form of material recovered by the process. For example, if it is desired to extract a certain component early in the recycling process, e.g., due to a shortage of that particular component, then the appropriate process flow may be selected to obtain the desired component early in the process rather than retaining a significant quantity of the component for extended time periods within the recycling process. For example, if it is desired to recover the bulk of the ionomer early in the process then the process of this specification may be selected, as the initial step of removing the catalyst layers from the bulk ionomer membrane ensures that the bulk ionomer membrane can be recovered and processed quickly while the ionomer and PGMs in the catalyst layers are subjected to further processing to perform the various separation steps.

Methods for recovering ionomers have been described in U.S. Pat. No. 7,255,798 and WO2016/156815 and such methods can be integrated into the process flows of the present specification as described above. As discussed above, it is often the case that different ionomers may be used in one or both of the catalyst layers compared to the ionomer in the bulk membrane. Different ionomers can be selected to provide performance improvements in end applications. It is also possible to use blends of ionomers or have layers of different ionomers within the bulk polymer membrane. In such cases, the process flows of the present specification can be useful in separating the bulk polymer membrane from the catalyst layers at the start of the process flow. If different ionomers are used in the catalyst layers compared to the bulk membrane, then such a separation can be useful to separate the different ionomers prior to further processing.

### Catalyst Layer Delamination Process

The waste catalyst coated membrane can be contacted with a mixture of an alcohol and water and agitated in order to delaminate both of the first and second catalyst layers from the membrane without dispersing the membrane. The first and second catalyst layers are dispersed in the mixture of alcohol and water forming a catalyst layer dispersion comprising the first catalyst, the first catalyst layer ionomer, the second catalyst, and the second catalyst layer ionomer.

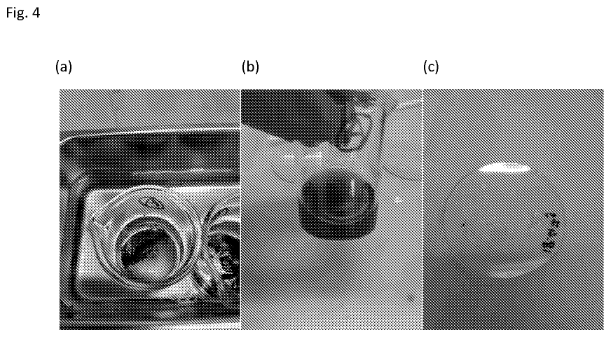

FIG. 4 shows: (a) a catalyst coated membrane subject to size reduction (cutting) and immersed in an 80:20 alcohol: water mixture (left hand image); (b) after ultra-sonication wherein the catalyst layer was dispersed in solution (middle image); and (c) the delaminated, clean and clear membrane recovered from the alcohol: water mixture (right hand image).

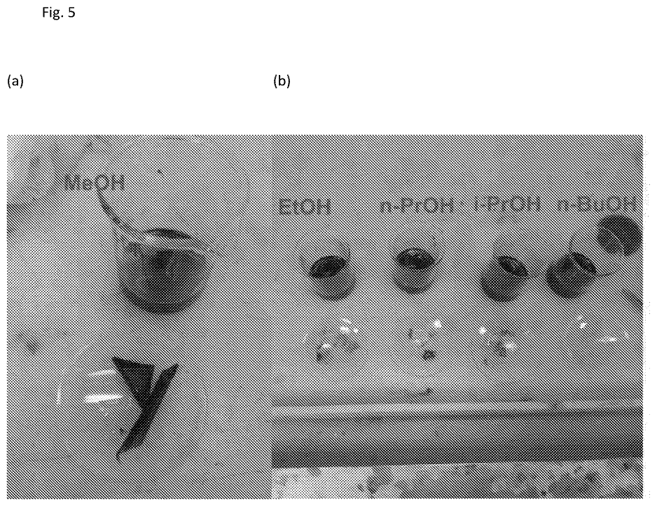

The alcohol in the mixture of the alcohol and water is selected from n-butanol, n-propanol, i-propanol, or ethanol. It has been found that while methanol and water is ineffective at delaminating catalyst layers from an ionomer membrane, a mixture of n-butanol, n-propanol, i-propanol, or ethanol with water can effectively delaminate the catalyst layers and disperse the catalyst layer ionomer without dispersing the bulk ionomer membrane. The order of effectiveness of these alcohols at achieving delamination of catalyst layers and recovery of clean and clear membrane is as follows: n-butanol>n-propanol>i-propanol>ethanol. Hence, the alcohol is preferably selected from n-butanol, n-propanol, or i-propanol, more preferably n-butanol or n-propanol, and most preferably n-butanol. FIG. 5 shows images of dispersions and recovered membranes after treatment of catalyst coated membranes in a range of different alcohol: water mixtures indicating that methanol was not effective at delaminating catalyst layers from membrane (image a) whereas the order of effectiveness of other alcohols at achieving delamination of catalyst layers and recovery of clean and clear membrane was as follows: n-butanol>n-propanol>i-propanol>ethanol (image b).

The mixture of alcohol and water may have a volume ratio of alcohol: water between 0 and 1 and which is advantageously: at least 50:50, 60:40, or 70:30; no more than 95:5, 90:10, or 85:15; or within a range defined by any combination of the aforementioned lower and upper limits. The ratio can be optimized to enable effective dispersion of the catalyst layer ionomer without dispersing the bulk ionomer membrane for a given set of process conditions and CCM feed materials for recycling.

The mixture of the alcohol and water can be agitated by sonification. Ultra-sonification has been found to be effective for use in the present method. Contacting of the waste catalyst coated membrane with the mixture of alcohol and water to delaminate the catalyst layers can be performed for a time period of: at least 10 minutes, 20 minutes, 30 minutes or 1 hour; no more than 5 hours, 3 hours, or 2 hours; or within a range defined by any combination of the aforementioned lower and upper limits. The specific time period for the deamination step with depend on a given set of process conditions (type/concentration of alcohol, temperature, pressure, agitation, etc.) and type of CCM feed material for recycling.

Advantageously, the waste catalyst coated membrane is processed into a plurality of pieces (e.g. by cutting) prior to contacting with the mixture of alcohol and water. This can aid clean delamination of the catalyst layers from the bulk ionomer membrane as well as making it easier to handle and process large areas of waste catalyst coated membrane material.

In relation to the above, it has been noted that certain prior methods for recycling CCMs have used pure ethylene glycol and heat, where the CCM undergoes a full dispersion including ionomer in the bulk membrane as well as in the catalyst layers. Certain prior art methods have also mentioned the use of alcohol/water mixtures in general terms for recycling of the catalyst materials. The difference here is that specific alcohol/water systems are used, and conditions tuned, to selectively separate and recycle different ionomers in the bulk membrane and catalyst layers.

### Further Processing to Recover Ionomer From Catalyst Layer Material

Processing steps to recover ionomer from catalyst layer material may comprise:
Optionally convert ionomer to salt form
Heat to disperse ionomer
   High temperature sufficient for dispersion, optionally in an autoclave
   Separation of catalyst and catalyst support from ionomer dispersion using:
      Centrifugation, and/or
      Filtration, e.g.,
         Ultrafiltration
         Membrane filtration, and/or
         Cross-flow filtration
Ion-exchange to remove metal contaminants
Optionally convert back to acid form

### Further Processing to Recover Ionomer From Membrane

Processing Steps to Recover Ionomer From the Bulk Membrane May Comprise:
Optionally convert ionomer to salt form (e.g., prior to dispersing the membrane ionomer)
Disperse in water (hydrothermal process using autoclave), an aqueous solution, an alkaline aqueous solution, an organic solvent (e.g., alcohols, diols, phosphate, ketone, DMSO, DMF, NMP), or a mixture thereof.
Filter particulates
Ion-exchange to remove metal contaminants
Optionally convert back to acid form
Optionally treat the waste solvent by ion exchange or contacting with an active media such as activated carbon/charcoal.

### Further Processing of Ionomer

Ionomer recovered from the bulk membrane and/or catalyst layers in accordance with the aforementioned processed can be further purified by subjecting to ultrafiltration processes and subjected to separation and/or blending processes.

### Processing Steps for Catalyst Layer Material

The catalyst layer material which is separated from the bulk polymer membrane using the previously described process will generally comprise ionomer, at least one catalyst comprising platinum, palladium and/or ruthenium, and at least one catalyst comprising iridium. This material can be processed to recover the PGMs and ionomer using the following generic method:
(a) treating the material with a heated solution comprising an acid and an oxidant, wherein platinum, palladium and/or ruthenium is leached from the material into the solution which is separated from remaining solid components of the material;
(b) treating the material with a solvent to disperse the ionomer and recover a dispersion of ionomer, wherein the dispersion of the ionomer is performed before or after the leaching of the platinum, palladium and/or ruthenium; and
(c) treating the material to extract iridium by one or both of:
   (i) separating the remaining solid iridium containing catalyst material from the dispersion of ionomer after the leaching of the platinum, palladium, rhodium, and/or ruthenium and the dispersion of the ionomer; and
   (ii) leaching the iridium from the material using a heated solution comprising an acid and a reducing agent and separating the solution comprising the leached iridium from remaining solid components of the material, wherein the iridium leaching is performed before or after the leaching of the platinum, palladium and/or ruthenium.

The method steps can be performed to recover Pt, Ir, and ionomer in any order. That is: Pt—Ir-Ionomer; Ir—Pt-Ionomer; Ionomer-Pt—Ir; Ionomer-Ir—Pt; Pt-Ionomer-Ir; or Ir-Ionomer-Pt.

The following description will focus on an example which includes a platinum catalyst and an iridium-based catalyst (e.g. IrOx). However, the same approach can be used if the platinum catalyst is replaced with a palladium catalyst, a ruthenium catalyst, a mixed PGM catalyst comprising a combination of at least two of platinum, palladium, and ruthenium, or a catalyst comprising at least one PGM and at least one non-PGM metal (e.g. PtCo).

The acid used in one or both of the iridium leach and the platinum leach is optionally hydrochloric acid. Furthermore, one or both of the solutions used for the leach of platinum and iridium are preferably heated to a temperature of: at least 50 °C, 60 °C, or 70 °C; no more than 160 °C, 100 °C, or 90 °C; or within a range defined by any combination of the aforementioned lower and upper limits, wherein if the solution is heated above 100 °C then this is done in a pressurized vessel. The oxidant for the leach of platinum can comprise, for example, a chlorate salt such as sodium chlorate solution or chlorine gas (e.g., generated electrolytically in-situ). The oxidant can be added to the hydrochloric acid solution after heating up to the aforementioned temperature. The solution may comprise concentrated HCl of, for example, approximately 6M HCl.

Separation of the solution containing the leached platinum may be achieved via filtration. The separated solution may be concentrated by boiling the solution down to a suitable PGM concentration for further processing. Alternatively, the leachate can be recirculated to leach platinum from further waste catalyst coated membrane material, recirculation being repeated as required until a target concentration of PGM is reached. The PGM containing leachate is then further processed to extract the platinum from the acidic solution using known techniques. The remaining solid components of the waste catalyst layer material can be processed separately.

The method further comprises a step to extract iridium from the waste catalyst layer material. This may be achieved by leaching of Ir species from the waste catalyst layer material via a reductive dissolve process using an acid (such as 8 to 12 M HCl) and a reductant (such as hydrazine, NaBH₄, or ammonium oxalate), yielding an Ir-containing acidic liquor. WO2021083758 describes several examples of such a process for the dissolution of Ir in a reductive HCl environment. Since the previously described oxidative acidic platinum leach does not leach iridium to any significant extent, then such a reductive acidic leaching process step for the iridium can be performed after the oxidative acidic leaching step for platinum. However, it is also envisaged that the iridium leach can be performed prior to the platinum leach. The proposed route according to this example is thus a two-step process involving the selective leaching of Ir and Pt species from the waste CCM, without the need for incineration or other otherwise destructive processing. The steps are as follows and could be conducted in any order:
1. Leaching of Ir species via a reductive dissolve process using an acid (such as HCl or nitric acid) and a reductant (such as hydrazine), yielding an Ir-containing acidic liquor, and undissolved residue.
2. Leaching of Pt species via an oxidative dissolve process using an acid (such as HCl) and an oxidant (such as a chlorate or Cl₂), yielding a Pt-containing acidic liquor, and undissolved residue.

Liquors generated from steps one and two can then be directed to their respective purification processes (if significant impurities exist) or used directly as a precursor for new catalyst materials. The solid residues may then undergo further leaching to remove the remaining PGM species, with the resulting ionomer residue then recycled.

This process selectively recovers PGMs from waste catalyst layer materials, allowing for further simple recovery processes for the remaining catalyst layer ionomer. As such, the process provides a full recovery and recycle route for both the PGMs and ionomer. The two-step process involving Pt and Ir leaches enables a simple and quick route to separate and recover both Ir and Pt with the possibility to directly feeding metal solutions back into catalyst manufacturing processes. With an estimated demand of approximately 800 kOzt Pt and 160 kOzt Ir for fuel cell and electrolyser CCMs by 2040, the compact, bespoke nature of the process will reduce lead-time and increase metal liquidity. The process enables the creation of a closed loop cycle for scrap CCM material, not only the PGMs but also the ionomer. The process also enables open loop recycling of end-of-life CCMs.

As an alternative to leaching iridium as described above, the iridium (or iridium oxide) material can be separated from the catalyst layer ionomer by dispersing the ionomer. In this case, platinum can be leached from the waste catalyst layer material as previously described and then the remaining waste catalyst layer material comprising solid ionomer and iridium species can be subjected to an ionomer dispersion yielding a slurry comprising an ionomer dispersion in which solid iridium species are disposed. The ionomer dispersion can be separated from the solid iridium species using a solid/liquid separation (e.g., filtration or centrifugation) to yield an ionomer dispersion for recycling. The remaining solid iridium material may be directly re-used in a CCM manufacturing process or may be refined prior to re-use. Alternatively, the catalyst layer ionomer can be dispersed prior to platinum leaching to yield a mixed PGM residue for further processing.

In one such example, the waste catalyst layer material is subjected to HCl/oxidant (e.g. chlorine) treatment to leach platinum, and optionally also ruthenium if present in the waste catalyst layer material. The liquor from this treatment can then treated to remove base metals such as nickel and cobalt (using, for example, a cationic exchange resin), undergo Ru removal via a distillation or other process, and then enter directly into a Pt refining process stream to recover the Pt. The residual waste catalyst layer material from the leach can undergo a process involving heating/autoclaving the material in a solvent (e.g., an alcoholic solvent) to disperse the ionomer. The ionomer dispersion can then be separated from the Ir containing solids via filtration or centrifugation. The ionomer dispersion can then go on for further processing to be recycled back to manufacture new CCMs either as a pure or blended material. Examples of processes for recycling perfluorosulphonic acid ionomer are described in U.S. Pat. No. 7,255,798 and WO2016/156815. The Ir catalyst, due to its inherent stability, could be reused without further processing or the Ir solids can be refined to recover the Ir metal.

In the aforementioned process, the platinum leaching step is performed on the waste catalyst layer material prior to the step of dispersing the ionomer. However, in an alternative method the ionomer dispersion is performed prior to the platinum leaching step. In this case, the waste catalyst layer material is heated in a solvent (e.g., an alcoholic solvent) to elevated temperature and optionally autoclaved to disperse the ionomer. A solid/liquid separation is performed on the resultant slurry (e.g., by either filtration or centrifugation). The solution will contain dispersed ionomer which will then be further processed to be recycled back to manufacture new CCMs. The PGM residue may be dried to ensure complete removal of organic solvent before being subject to a HCl/chlorine leach treatment as previously described. The liquor from the leach can be treated to remove base metals such as Ni and/or Co (e.g., for example, a cationic exchange resin), undergo Ru removal (e.g., via a distillation process) and then the remaining platinum containing solution provided into a Pt refining process stream to recover the Pt as previously described. The residue from the leach process still contains the Ir catalyst which will have been largely unchanged due to its stability. This can either be processed in order to directly reuse the Ir catalyst material (e.g., IrOx) or the residue can be refined to recover the Ir.

### Processing of Waste Dispersion Media

After processing the membrane to recover the membrane ionomer and/or after processing the catalyst layer slurry to disperse and recover the first and second catalyst layer ionomers, a waste dispersion media is generated comprising a solvent and fluorine containing species such as soluble fluorine containing organic compounds, soluble fluoride species, and/or insoluble fluorine containing species such as insoluble metal fluorides. The waste dispersion media can be treated to reduce the concentration of fluorine containing species in the solvent, after which the solvent can be safely discarded or recycled for re-use in processing further membrane and/or catalyst layer slurry material. The treatment of the waste dispersion media may comprise contacting the waste dispersion media with a solid adsorbent and/or an ion exchange media to reduce the concentration of fluorine containing species in the solvent, optionally also reducing the concentration of residual metal cations in the solvent. The waste dispersion media may also be subjected to crossflow filtration or ultrafiltration, e.g., prior to contacting the waste dispersion media with an adsorbent such as activated charcoal and/or contacting with one or more ion exchange media.

In light of the above, the present specification also provides a treatment method for dispersion media (e.g., water, alkaline aqueous solutions, or water/alcohol mixtures) used in the recycling of ionomers from CCM membrane components and/or catalyst layer components. The used dispersion media can be contacted with a cationic ion exchange resin and optionally an anionic ion exchange resin and/or a capture media such as activated charcoal. The resulting treated used dispersion media has a reduced level of low molecular weight soluble organic compounds such as fluorinated or partially fluorinated sulphonic or carboxylic acids, and (optionally) a reduced level of residual cations such as iron, nickel, copper, and chrome. The treated dispersion media can subsequently be re-used in a closed loop system or safely discarded. Optionally, the waste dispersion media can be first subjected to crossflow filtration or ultrafiltration step to concentrate the impurities prior to the capture and disposal of fluorine containing impurities. The ion exchanged resin can be regenerated. The waste stream can be concentrated and discarded through pyrolysis (e.g., using a thermal oxidizer). Activated carbon columns can also be pyrolyzed at end-of-life.

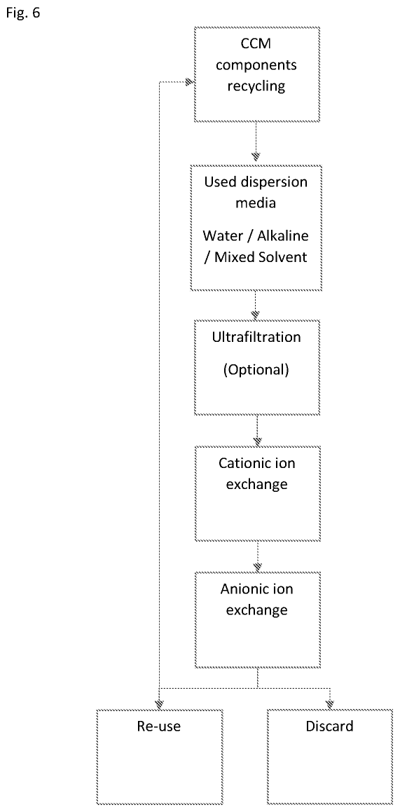

FIG. 6 shows an example of the process flow for treatment of waste dispersion media. The advantages of this waste dispersion media processing method include a reduction of emissions resulting from the recycling of ionomers from production scrap and/or end-of-life fuel cell and/or water electrolyser CCM components. Reduction in water consumption is also advantageous.

Examples for solid media which can be used to extract fluorine containing species from the waste dispersion media include adsorbents such as a carbon-based adsorbent such as activated charcoal, a silica-based adsorbent, a metal-based adsorbent, and/or an ion exchange resin that can adsorb/react with F. Ion exchange resins include, for example, zirconium or aluminium pre-loaded chelating resins with amino-methyl phosphonic acid functionality, a strongly basic anion exchange resin containing quaternary ammonium functional groups, an iminodiacetic acid functionalized cation exchange resin pre-loaded with metal ions (such as Fe³⁺, Al³⁺, Ce³⁺, and/or La³⁺), or a cryptand ligand. The adsorbent may be a silica-based adsorbent, for example a glass material such as a barium-silicate glass material which can be provided in glass powder form. The fluorine containing waste dispersion media can be passed through a packed column or bed of such an adsorbent to remove fluorine containing species. The adsorbent can periodically be replaced and/or treated to remove the fluorine and re-generate the adsorbent for re-use.

### SUMMARY

The present methodology combines operations to create a process for ionomer and PGM recovery from CCM including delamination (and optionally communition) of catalyst layers from the bulk membrane to generate a more concentrated ionomer containing membrane stream and a more concentrated PGM containing catalyst layer stream from which the PGM can be leached more effectively while also enabling recovery of catalyst layer ionomer.

Alcohol/water solvent systems are provided and through tuning conditions (type/concentration of alcohol, temperature, pressure, time, agitation) it is possible to treat CCMs (or MEAs) to achieve one or the following outcomes:

### 1. Delamination of the Catalyst Layer(s) Only.

2. Delamination of the catalyst layer(s) with dispersion of ionomer selective to catalyst layer ionomers.
3. Delamination of the catalyst layer with full dispersion of ionomer in all 3 components (membrane, anode, and cathode catalyst layers).

The process can be preceded with and/or followed with one or more of the following steps:
4. Leaching of PGM from catalyst layers.
5. Dispersion of ionomer from PGM-leached catalyst layers.
6. Dispersion of ionomer from membrane.

Conditions can be tuned to achieve the desired outcome. A particular point to note with the present specification is the purpose of using the alcohol/water mixes. Previous work focused on selective separation and recycling of PGMs, e.g., keeping the anode PGMs separate from cathode PGMs. In contrast, here we identify that certain alcohol/water mixes can be used for ionomer/ionomer separation. Most ionomer recycling processes of CCMs look at full dispersion of all the ionomers in the CCM which means that ionomer to ionomer separation has to be dealt with in another way. It is highly likely that future CCMs will contain multiple ionomers. This method of delaminating the catalyst layer ionomer from the membrane provides an industrial viable approach to dealing with such multi-ionomer CCMs and represents potentially the best/only way to separate ionomers during a scaled industrial CCM recycling process if different ionomers are used in catalyst layers and bulk membrane.

The drivers for PFSA recycling generally are:
1. Legislation-Tighter regulations on the use of PFAs due to persistence in the environment.
2. Financial-Cost of ionomer can be equivalent to that of precious metals in PEM products.
3. Environmental sustainability-Current route to PGM recovery involves incineration releasing high levels of toxic and corrosive HF and associated CO₂ footprint.

Establishing an industrially viable PFSA recycling process strengthens the appeal of hydrogen technologies using CCMs and provides the opportunity for a circular closed loop recycling route for hydrogen technology products. More specifically, this invention provides a methodology for mixed ionomer recycling with flexibility for scale up challenges and for future streams of waste material to be recycled. In particular, the method is advantageous in that it enables waste dispersion media generated during the recycling process to be treated to remove harmful fluorine containing species so that they are safe to dispose of or, advantageously, so that the solvents used in the process can be recycled and re-used in the process.

While this invention has been particularly shown and described with reference to certain examples, it will be understood to those skilled in the art that various changes in form and detail may be made without departing from the scope of the invention as defined by the appended claims.

1-16. (canceled)

17. A method of recycling waste membrane comprising fluorinated ionomer, the method comprising:
dispersing the fluorinated ionomer from the waste membrane in a solvent;
separating the fluorinated ionomer from the solvent, wherein after separating the fluorinated ionomer, the solvent is in the form of a waste dispersion media comprising the solvent and fluorine containing species; and,
treating the waste dispersion media to reduce the concentration of fluorine containing species in the solvent.

18. The method according to claim 17, wherein after treating the waste dispersion media to reduce the concentration of fluorine containing species in the solvent, the solvent is recycled and re-used to process further waste membrane material.

19. The method according to claim 17, wherein the fluorine containing species in the waste dispersion media comprise one or more of:
soluble fluorine containing organic compounds dissolved in the solvent;
soluble ionic fluoride species dissolved in the solvent; and,
insoluble fluorine containing compounds dispersed in the solvent.

20. The method according to claim 17, wherein the treatment of the waste dispersion media comprises one or more of the following steps to reduce the concentration of fluorine containing species in the solvent:
contacting the waste dispersion media with a solid adsorbent;
contacting the waste dispersion media with an ion exchange media;
filtering the waste dispersion media.

21. The method according to claim 20, wherein the treatment of the waste dispersion media comprises contacting the waste dispersion media with activated charcoal.

22. The method according to claim 20, wherein the treatment of the waste dispersion media comprises contacting the waste dispersion media with a cationic ion exchange resin.

23. The method according to claim 20, wherein the treatment of the waste dispersion media comprises contacting the waste dispersion media with an anionic ion exchange resin.

24. The method according to claim 17, wherein the treatment of the waste dispersion media also reduces the concentration of residual metal cations in the solvent.

25. The method according to claim 24, wherein the metal cations include one or more of iron, nickel, copper, and chrome.

26. The method according to claim 17, wherein the waste dispersion media is subjected to crossflow filtration or ultrafiltration.

27. The method according to claim 17, wherein the solvent is selected from water, an alkaline aqueous solution, or a water/alcohol mixture.

28. The method according to claim 17, wherein the waste membrane is a waste catalyst coated membrane comprising a membrane including a membrane ionomer, a first catalyst layer disposed on one side of the membrane, the first catalyst layer comprising a first catalyst and a first catalyst layer ionomer, and a second catalyst layer disposed on an opposite side of the membrane, the second catalyst layer comprising a second catalyst and a second catalyst layer ionomer, and
wherein the waste dispersion media is generated from a dispersion of at least one of the membrane ionomer, the first catalyst layer ionomer, and the second catalyst layer ionomer.

29. The method according to claim 28, comprising:
contacting the waste catalyst coated membrane with a solvent to delaminate both of the first and second catalyst layers from the membrane without dispersing the membrane, wherein the first and second catalyst layers form a catalyst layer slurry comprising the first catalyst, the first catalyst layer ionomer, the second catalyst, and the second catalyst layer ionomer,
separating the membrane from the catalyst layer slurry,
processing the membrane to disperse and recover the membrane ionomer, and
processing the catalyst layer slurry to disperse and recover the first and second catalyst layer ionomers in a solvent, and separate and recover the first and second catalysts or components thereof,
wherein processing of the membrane generates a first waste dispersion media comprising a first solvent and fluorine containing species in the first solvent, the first waste dispersion media being treated to reduce the concentration of fluorine containing species in the first solvent, and
wherein processing of the catalyst layer slurry generates a second waste dispersion media comprising a second solvent and fluorine containing species in the second solvent, the second waste dispersion media also being treated to reduce the concentration of fluorine containing species in the second solvent.

30. The method according to claim 29, wherein the first and second waste dispersion media are combined prior to treatment in order to reduce the concentration of fluorine containing species.

31. The method according to claim 29, wherein the first and second waste dispersion media are treated separately in order to reduce the concentration of fluorine containing species.
